(19) United States
(12) Patent Application Publication
(10) Pub. No.: US 2021/0357596 A1
(43) Pub. Date: Nov. 18, 2021

(54) INTELLIGENT LOCALIZATION OF RESOURCE DATA

(71) Applicant: MICROSOFT TECHNOLOGY LICENSING, LLC, Redmond, WA (US)

(72) Inventors: Jack MILLER, Seattle, WA (US); Eshwar STALIN, Sammamish, WA (US)

(73) Assignee: MICROSOFT TECHNOLOGY LICENSING, LLC, Redmond, WA (US)

(21) Appl. No.: 16/875,670

(22) Filed: May 15, 2020

(51) Int. Cl. G06F 40/58; G06F 40/51; G06F 9/48; G06N 3/08

(52) U.S. Cl. CPC G06F 40/58; G06N 3/08; G06F 9/4881; G06F 40/51

(57) ABSTRACT

A method of and system for translating a software resource of an application in real time is disclosed. The method may include receiving an indication to load the software resource, the software resource being in a first language, determining if the first language is a preferred language for a user, if the first language is not the preferred language for the user, sending a request to a machine translation model to translate the software resource from the first language to the preferred language, receiving a translated software resource in the preferred language, and loading the translated software resource.

### TECHNICAL FIELD

This disclosure relates generally to localization of software resources, and more particularly, to real time translation of software resources in a client device.

### BACKGROUND

Many software applications include large quantities of resource data (e.g., resource strings). For example, many applications store resource strings that need to be displayed in a user interface (UI) of the application. These UIs are often provided to a user to enable the user to interact with the software program. However, in order for the user to interact with the program, the resource strings would need to be in a language the user understand. Because computers are commonly used in many different regions around the world, to effectively provide a software application to a global market, the resource data would need to be translated into many different languages.

The process of translating the resource data to a different language is, however, complex and time-consuming. The process often requires the developer to first choose the languages the developer plans to offer their software program in. Once the languages are selected, the developer would need to hire a service for translating the content of the program (e.g. the resource strings) into each separate selected language. Once the translations are available, the developer would need to package the translated resources with their program in accordance with an operating system's specifications. This is a time-consuming, costly, and complex process that may need to reoccur not only the first time the software program is being released, but also each time the developer releases updates to the software program.

Hence, there is a need for an improved method and system of localization of software resources.

### SUMMARY

In one general aspect, the instant disclosure presents a device having a processor, an operating system and a memory in communication with the processor where the memory comprises executable instructions that, when executed by the processors, cause the device to perform multiple functions. The function may include receiving an indication to load a software resource for an application, the software resource being in a first language, determining if the first language is a preferred language for a user of the device, if the first language is not the preferred language for the user of the device, sending a request to a machine translation model to translate the software resource from the first language to the preferred language, receiving a translated software resource in the preferred language; and loading the translated software resource.

In yet another general aspect, the instant application describes a method for translating a software resource of an application in real time. The method may include receiving an indication to load the software resource, the software resource being in a first language, determining if the first language is a preferred language for a user, if the first language is not the preferred language for the user, sending a request to a machine translation model to translate the software resource from the first language to the preferred language, receiving a translated software resource in the preferred language, and loading the translated software resource.

In a further general aspect, the instant application describes a non-transitory computer readable medium on which are stored instructions that when executed cause a programmable device to receive an indication to load a software resource for an application, the software resource being in a first language, determine if the first language is a preferred language for a user of the device, if the first language is not the preferred language for the user of the device, sending a request to a machine translation model to translate the software resource from the first language to the preferred language, receive a translated software resource in the preferred language, and load the translated software resource.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 is a flow diagram for performing intelligent translation of software resources.

FIG. 3 is a block diagram illustrating an example software architecture, various portions of which may be used in conjunction with various hardware architectures herein described.

FIG. 4 is a block diagram illustrating components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

Software applications are used by people from around the world who speak many different languages. As a result, to reach the global market, software applications may need to be made available in many different languages. Many software applications include resource strings (e.g., text) that need to be displayed in a UI of the application. To provide a software application in a different language, all such resource strings may need be translated (e.g., localized) into that language. Translating all resource strings of the software application to a different language, however, is a time-consuming process that is often costly. For example, it may require the developer to hire a service to translate the resource strings to the different language. To provide the software application in many different languages, the process would need to be repeated for each different language. This not only significantly increases the amount of time and cost required for offering software applications in different languages, it also involves a complex process of procuring the required translation services and ensuring that the resulting translations are accurate.

Furthermore, when different software applications employ different services for translating their resource strings, the resulting programs may be translated differently. That is because different translators may use different terminology for the same terms. As a result, different software applications offered in a language may include different phrases to describe the same process. For example, the word “save as” may be translated differently by different people and as a result two different software applications may refer to the same process differently. This may result in an inconsistent user experience which can lead to user confusion and dissatisfaction.

Still further, to provide the software application in many different languages, the resource strings for each different language may need to be stored and made available with the software application. This may result in the software application having numerous resource files that take up a large amount of space. As an example, resources of one language may take about 100 MB of space in one application. Thus, when multiple languages are offered, resources for all the languages may take a significantly large amount of disk space. The large amount of space required can lead to inefficient deployments, prohibitive memory space requirements, and in general increased footprint for an application.

To address these technical problems and more, in an example, this description provides a technical solution for a method of intelligent localization of software resources in an operating system. To improve the current methods of localization of software resources, the technical solution provides a method of providing real time translations of resources in an operating system. This may involve using one or more machine learning (ML) models that provide real time translation of resources, as needed. This may occur at the computing device that launches the software application and may be initiated by the operating system, thus obviating the need for providing localized resources in many different languages beforehand. Thus, the technical solution offers a very efficient mechanism for localizing software resources.

As will be understood by persons of skill in the art upon reading this disclosure, benefits and advantages provided by such technical solutions can include, but are not limited to, a solution to the technical problems of inefficient, costly, and resource-intensive processes of providing software applications in different languages. Technical solutions and implementations provided herein optimize and improve the process of localizing software resources and may lead to smaller size software applications. Thus, the benefits provided by these technical solutions include providing increased efficiency in developing software applications and in deployment and storage of software application. Furthermore, the resulting software applications may provide a more uniform user experience thus increasing user satisfaction.

As a general matter, the methods and systems described here may include, or otherwise make use of, a machine-trained model to provide translations. Machine learning (ML) generally includes various algorithms that a computer automatically builds and improves over time. The foundation of these algorithms is generally built on mathematics and statistics that can be employed to predict events, classify entities, diagnose problems, and model function approximations. As an example, a system can be trained using data generated by an ML model in order to identify patterns in natural languages, determine associations between words, identify proper grammar and/or identify proper formatting. Such training may be made following the accumulation, review, and/or analysis of user data from a large number of users over time. Such user data is configured to provide the ML algorithm (MLA) with an initial or ongoing training set. In addition, in some implementations, a user device can be configured to transmit data captured locally during use of relevant application(s) to a local or remote ML algorithm and provide supplemental training data that can serve to fine-tune or increase the effectiveness of the MLA. The supplemental data can also be used to improve the training set for future application versions or updates to the current application.

In different implementations, a training system may be used that includes an initial ML model (which may be referred to as an “ML model trainer”) configured to generate a subsequent trained ML model from training data obtained from a training data repository or from device-generated data. The generation of both the initial and subsequent trained ML model may be referred to as “training” or “learning.” The training system may include and/or have access to substantial computation resources for training, such as a cloud, including many computer server systems adapted for machine learning training. In some implementations, the ML model trainer is configured to automatically generate multiple different ML models from the same or similar training data for comparison. For example, different underlying MLAs, such as, but not limited to, decision trees, random decision forests, neural networks, deep learning (for example, convolutional neural networks), support vector machines, regression (for example, support vector regression, Bayesian linear regression, or Gaussian process regression) may be trained. As another example, size or complexity of a model may be varied between different ML models, such as a maximum depth for decision trees, or a number and/or size of hidden layers in a convolutional neural network. As another example, different training approaches may be used for training different ML models, such as, but not limited to, selection of training, validation, and test sets of training data, ordering and/or weighting of training data items, or numbers of training iterations. One or more of the resulting multiple trained ML models may be selected based on factors such as, but not limited to, accuracy, computational efficiency, and/or power efficiency. In some implementations, a single trained ML model may be produced.

The training data may be continually updated, and one or more of the ML models used by the system can be revised or regenerated to reflect the updates to the training data. Over time, the training system (whether stored remotely, locally, or both) can be configured to receive and accumulate more training data items, thereby increasing the amount and variety of training data available for ML model training, resulting in increased accuracy, effectiveness, and robustness of trained ML models.

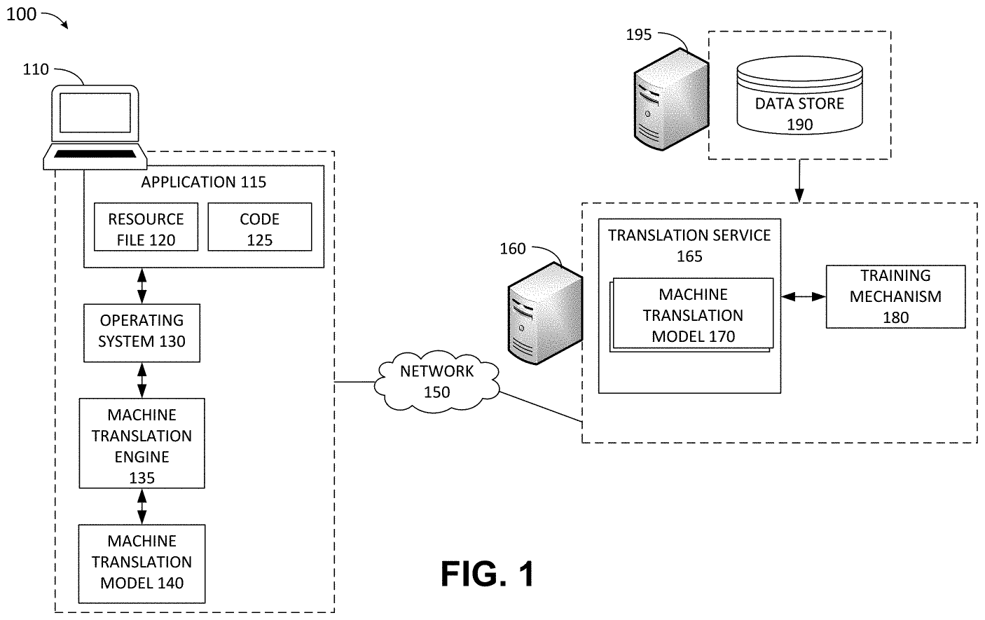

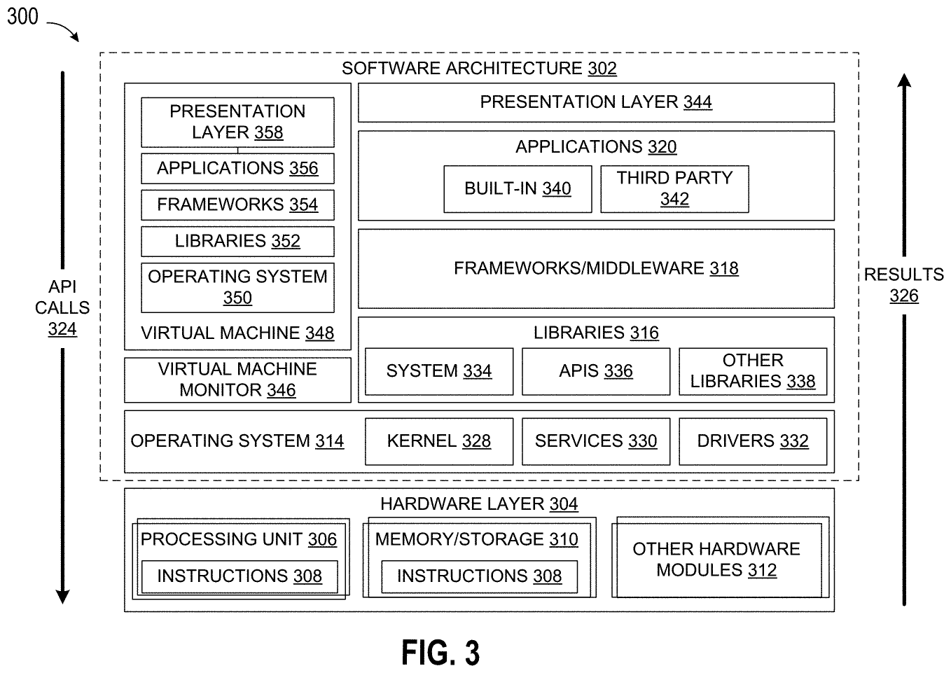

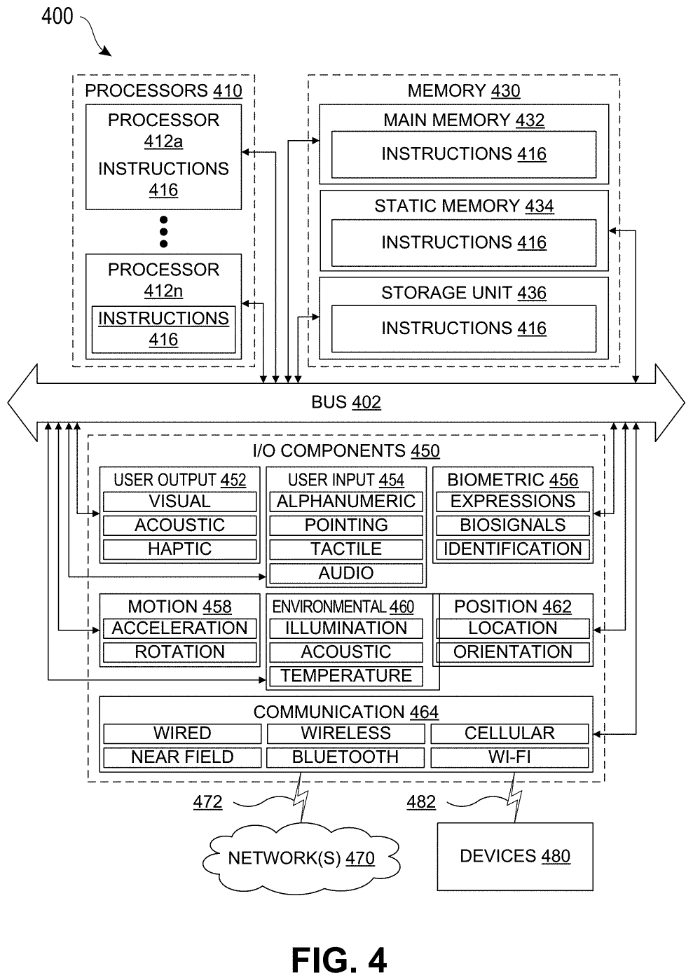

FIG. 1 illustrates an example system 100, upon which aspects of this disclosure may be implemented. The system 100 may include a client device 110 on which a software application such as application 115 may be executed. The client device 110 may be a personal or handheld computing device having or being connected to input/output elements that enable a user to interact with the application 115 on the client device 110. Examples of suitable client devices 110 include but are not limited to personal computers, desktop computers, laptop computers, mobile telephones, smart phones, tablets, phablets, digital assistant devices, smart watches, wearable computers, gaming devices/computers, televisions, and the like. The internal hardware structure of a client device is discussed in greater detail in regard to FIGS. 3 and 4.

The application 115 may be a software program executed on the client device 110 that configures the device 110 to be responsive to user input to allow a user to interact with the application 115. The application 115 may include a variety of elements that together form a program or suite of programs. In an example, the application 115 includes one or more resource file(s) 120 and code 125. The code 125 may include software code for executing the application 115. The resource file 120 may include at least one resource file in which resource strings used by the application 115 are stored. The resource strings may include strings of characters (e.g., alphanumerical text) that may be displayed to a user by a UI of the application 115. To achieve that, the contents of resource file 120 may be accessed by executing components of the code 125. The executing components of the code 125 may retrieve the resource strings as needed by the application 115 to display the strings in one or more UI elements of the application 115. The resource strings in a resource file may be in a default language provided by the application 115. The default language may be a language in which the developer provides the application 115. For example, the default language may be United States English in which case characters displayed by the UI elements of the application 115 are in presented in United States English.

The client device 110 may include an operating system 130 for managing the functions of the client device 110 and executing applications such as application 115. In some implementations, the operating system 130 may have access to data relating to the user's preferred language. The user's preferred language may be a language selected by the user as the language they desire to use for the client device 110. The user's preferred language is often the language the user is proficient in and/or prefers to work in. In some implementations, the operating system 130 may provide an option (e.g., via a UI element) for the user to select a default language for the client device 110. The language selected by the user may be the user's preferred language. In some implementation, the operating system 130 may provide different options for selecting a default applications language and a default operating system language. In this manner, the user may be able to specify different preferred languages for various computer functions. In another example, the user may be able to add one or more additional languages to the user's default applications language. This occurs, for example, when the user speaks and/or works in two or more languages.

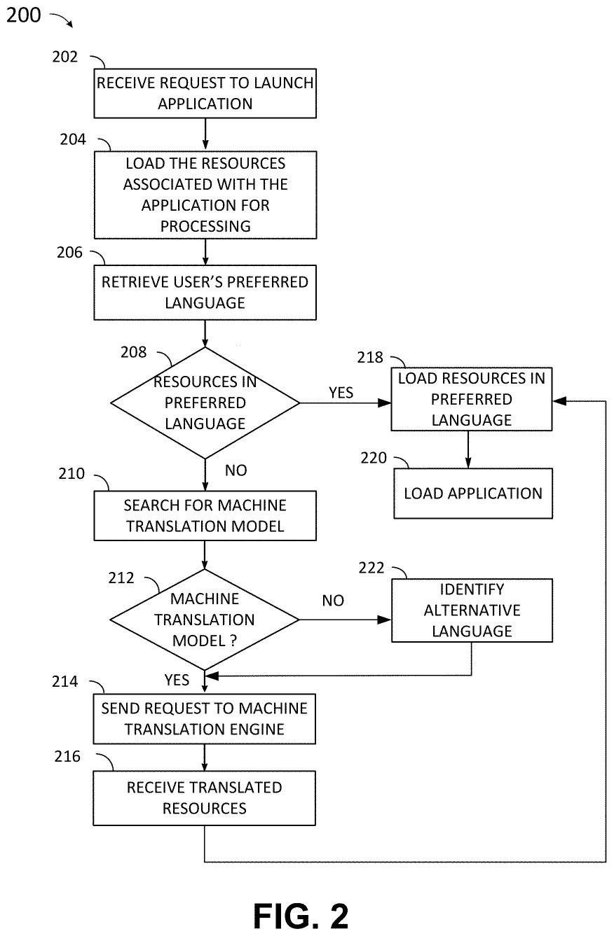

The information about the user's preferred applications language may be stored in a storage medium (e.g., in a database) and accessed by the operating system 130 when needed. For example, as discussed in more details below with respect to FIG. 2, the preferred language information may be accessed when a software application is launched by the operating system 130. In an example, the operating system 130 accesses the user's preferred language information to determine if the software applications' default language is the same as the user's preferred language. When the software applications' default language is different from the user's preferred language, the operating system 130 may utilize a machine translation engine 135 to facilitate translation of the software application's default language into the user's preferred language. To achieve this, existing operating system technologies may be modified to enable the operating system to determine if the application's localized content (e.g., resources in the resource file) are provided in the user's preferred language and if not to manage their translations.

To facilitate translations, the operating system 130 may be in communications with the machine translation engine 135, which may in turn be coupled to a machine translation model 140. The machine translation model 140 may be representative of one or more machine translation models that are stored on the client device 110 to provide software resource translations, as needed. In some implementations, a machine translation model 140 may include one or more ML models for translating text from one language to another. For example, a machine translation model may be an ML model designed for translating text from the software application's default language to the user's preferred language (e.g., United States English to French). A second ML model may provide translations from the software application's default language to a second user preferred language (e.g., United States English to Austrian German). Thus, each machine translation model may provide translations from one specific language to another specific language.

In some implementations, each machine translation model 140 includes an ML model that is capable of translating entire resource strings from the software application's default language to a different language. For example, the ML model may include a natural language processing (NLP) model and/or one or more neural network models that analyze each resource string (e.g., a word, a phrase, a sentence or multiple sentences), identify its context and format, translate the string from the default language to the different language, and provide proper grammar, formatting, placeholders and other non-translatable fragments that may migrate into the translation, and other linguistic information (e.g., capitalization, punctuation marks, etc.) for the translated string. In such implementations, the machine translation engine 135 may function as an intermediary between the operating system 130 and the machine translation model 140. For example, the machine translation engine 135 may receive the resource file and information about the user's preferred language for the application from the operating system, identify based on the user's preferred language the machine translation model (e.g., in instances where multiple machine translation models are stored on the client device 110) that should be used for translation and transmitting the resource file 120 to the identified machine translation model. The machine translation model 140 may receive the resource file 120, translate one or more resource strings in the resource file 120 to the user's preferred language and provide a translated resource file as an output to the machine translation engine 135. The machine translation engine 135 may provide the translated resource file to the operating system 130 for use in launching the application 115.

In alternative implementations, the machine translation model 140 merely functions as a dictionary by providing word translations. In such implementations, the machine translation engine 135 may include one or more ML models for receiving the word translations from the machine translation model 140 and turning the word translations into complete string translations. For example, the machine translation engine 135 may include one or more NLP models and/or one or more neural network models that analyze each resource string (e.g., a word, a phrase, a sentence or multiple sentences), identify its context and format, and utilize the word translations from the machine translation model 140 to generate translated strings having proper grammar formatting, placeholders and other non-translatable fragments that may migrate into the translation, and other linguistic information (e.g., capitalization, punctuation marks, etc.).

In some implementations, the client device 110 includes machine translation models for all languages supported by the operating system 130. For example, machine translation models for all supported languages may be preinstalled on the client device 110. In alternative implementations, to conserve storage space, the client device 110 includes a subset of the supported languages. In some implementations, once the user specifies a preferred language, client device 110 may obtain the machine translation model 140 for that language.

To achieve that, the client device 110 may be connected to a server 160 via a network 150. The network 150 may be a wired or wireless network(s) or a combination of wired and wireless networks that connect one or more elements of the system 100. The sever 160 may contain and/or execute a translation service 165 which may include a plurality of machine translation models 170. The server 110 may operate as a shared resource server located at an enterprise accessible by various computer client devices such as the client device 110. The server 160 may also operate as a cloud-based server for offering global translation services. Although shown as one server, the server 160 may represent multiple servers for performing various different operations. For example, the server 160 may include one or more processing servers for performing the operations of each of the machine translation models 170 and/or the training mechanism 180.

The translation service 165 may provide access to the machine translation models 170. For example, the translation service 165 may receive a request for providing a specific machine translation model 170 (e.g., machine translation model for translating United States English to French) from the client device 110. This may occur, for example, when the user utilizes a UI element of the operating system 130 in the client device 110 to select a new preferred language. In such an instance, if the client device 110 does not already include the machine translation model for translating from a default language to the new preferred language, the client device 110 may transmit a request to the translation service 165 to receive that machine translation model from the translation service 165. In response, the translation service 165 may deploy the requested machine translation model, from among the plurality of machine translation models 170, to the client device 110. In alternative implementations, the process of translating software application resources is performed by the translation service 165. For example, when a need to translate one or more resource strings in a resource file arises, the operating system 130 may transmit a request to the translation service 165 to provide real time translations, as needed.

The server 160 may be connected to or include a storage server 195 containing a data store 190. The data store 190 may function as a repository in which files and/or data sets (e.g., training data sets) may be stored. One or more ML models used by the translation service 165 and/or the machine translation model(s) 170 may be trained by a training mechanism 180. The training mechanism 180 may use training data sets stored in the data store 190 to provide initial and ongoing training for each of the models. Alternatively or additionally, the training mechanism 180 may use training data sets unrelated to the data store. This may include training data such as knowledge from public repositories (e.g., Internet), knowledge from other enterprise sources, or knowledge from other pre-trained mechanisms. In one implementation, the training mechanism 180 may use labeled training data from the data store 190 to train each of the models via deep neural network(s) or other types of ML models. The initial training may be performed in an offline stage. Additionally and/or alternatively, the one or more ML models may be trained using batch learning.

FIG. 2 is a flow diagram depicting an example method 200 for performing intelligent translation of software resources. In some implementations, the steps of method 200 may be performed by an operating system such as the operating system 130 of FIG. 1. At 202, method 200 may begin by receiving a request to launch an application. The request may be received when the user utilizes an input/output device to input a request to launch a desired application. Alternatively, the request is received each time the application has a need for displaying a resource string. For example, after the application has been launched, the user may utilize a function that requires displaying a UI element containing some text. When the need arises for this text, the application may send a request to the operating system to load the required resource string. The operating system may in turn proceed to perform the steps of method 200 to provide a translated version of the resource string. In such an instance, translations may be requested and provided on a just in time basis such that each resource string is translated in real time and when needed. In some implementations, the steps of method 200 are only performed the first time the application is launched on a device. Once the application is launched, the resources may be translated and stored on the device such that further translation is not needed. However, if there is a software update for the application, the operating system may be notified the next time the application is launched, and the process may be repeated.

Once a request is received by the operating system, method 200 may proceed to load the resources associated with the application for processing, at 204. This may be achieved by loading one or more resource files associated with the application. It should be noted that to achieve this, the application may be provided in an application package that separates the resource strings from other language-neutral portions of the application (e.g., resource strings are in a resource file which is separated from the code).

Once the application's resources are loaded, method 200 may proceed to retrieve the user's preferred language, at 206. This may occur, for example, by accessing a database at which user profile data is stored and may involve determining what language is the user's preferred language for applications. In some implementations, this involves retrieving the user's preferred language from the application. For example, the application itself may provide an option for the user to select a preferred language. In such instances, the user's preferred language for the application may be transmitted to the operating system along with the resources or separately as requested by the operating system. Once the resources are loaded and the user's preferred language is retrieved, the method 200 may determine, at 208, whether the loaded resources are available in the user's preferred language.

When it is determined that the resources are available in the user's preferred language (208, yes), method 200 may proceed to load the resources in the preferred language, at 218, before completing the process of loading the application, at 220. When it is determined, however, that the loaded resources are not available in the user's preferred language (208, no), method 200 may proceed to search for the machine translation model that corresponds with the user's preferred model, at 210. This may involve determining the applications' default language and searching for the machine translation model that translates content from the applications' default language to the user's preferred language at a storage medium associated with the client device on which the application is being launched.

After searching for the machine translation model, method 200 may proceed to determine if the required machine translation model is available locally on the client device, at 212. When it is determined that the required machine translation model is available (212, yes). Method 200 may proceed to send a request to a machine translation engine (e.g., the machine translation engine 135 of FIG. 1) to facilitate translation of the resources to the user's preferred language, at 214. As discussed above with respect to FIG. 1, the machine translation engine may determine and/or receive the application's default language and identify which machine translation model can provide the translations from the application's default language to the user's preferred language. The machine translation engine may then parse the resource file to send one or more needed resource strings to the machine translation model for translation. Alternatively, the machine translation engine may send the resource file directly to the machine translation model with a request for receiving translations for each resource string in the file. In response, the machine translation model may translate each resource string to the user's preferred language and return a resource file of translated resources. As such, method 200 may receive the translated resources, at 216, before proceeding to load the resources in the preferred language, at 218. Once the resources are loaded in the user's preferred language, method 200 may proceed with loading the application, at 220.

When it is determined, at 212, that the machine translation model for the user's preferred language is not available locally, the method 200 may proceed to identify an alternative language to provide for the application, at 222. In some implementations, this involves identifying a language that is associated with the user's preferred language. The operating system may examine the list of available machine translation models to identify a language that is associated with the user's preferred language. For example, if the user's preferred language is Austrian German, the operating system may examine the list of machine translation models to determine if any other machine translation models for any other German dialects are available. Once an alternative language for which a machine translation model is available is identified, method 200 may proceed to step 214 to send a request to the machine translation engine for translating the resources as discussed above.

In some implementations, if an appropriate alternative language is not identified at step 222, method 200 proceeds to inform the user that the application is not available in the user's preferred language. In such an instance, the operating system may proceed to load the application in the application's default language. In alternative implementations, the operating system sends a request to a translation service such as the translation service 165 of FIG. 1 to obtain the machine translation model for translating the resources from the application's default language to the user's preferred language. This may involve downloading the machine translation model to the user's device first before proceeding with translating the resources to the user's preferred language. In yet other alternative implementations, the operating system sends a request the translation service to provide real time translation of resources to the user's preferred language. In such an instance, the translation service may receive a copy of the resource file containing the needed resource string and provide a translated resource file in return.

In this manner, real time and as needed translations may be provided locally. The solution provided herein enables a computer system to easily expand and/or modify the number of supported languages offered by the operating system after the operating system has been released. Moreover, the solution may enable third-party providers to offer additional languages that are not supported by the operating system vendor. Furthermore, the solution may be extended to support updating of the machine translation models throughout the lifetime of the operating system. For example, when a machine translation model is updated, the operating system could re-translate all machine translated content using the new model. The re-translation could be done by re-translating all content on the device at once or by re-translating content as it is needed by applications.

In some implementations, the operating system provides an opt-in and/or opt-out feature that enables users and/or administrators to limit the translation functionality to certain applications and/or components. This may mean that when an application is listed in the exclusion list, the machine translation functionality would not be utilized. Alternatively, the operating system may only use the machine translation functionality on applications that have been explicitly added to the list of allowed applications. The decision relating to which applications are included in such lists may be made by the user or the application vendor.

Thus, in different implementations, a technical solution is provided for an improved method and system of providing intelligent translation of software resources. The technical solution provides a mechanism for efficiently providing translated resources as needed by utilizing the operating system and machine translation models to perform real time translation of resources. Thus, the technical solution provides a highly efficient mechanism for localizing software resources that not only saves time and costs associated with providing a software program in multiple language, but it also reduces system resources such as memory.

FIG. 3 is a block diagram 300 illustrating an example software architecture 302, various portions of which may be used in conjunction with various hardware architectures herein described, which may implement any of the above-described features. FIG. 3 is a non-limiting example of a software architecture and it will be appreciated that many other architectures may be implemented to facilitate the functionality described herein. The software architecture 302 may execute on hardware such as client devices, native application provider, web servers, server clusters, external services, and other servers. A representative hardware layer 304 includes a processing unit 306 and associated executable instructions 308. The executable instructions 308 represent executable instructions of the software architecture 302, including implementation of the methods, modules and so forth described herein.

The hardware layer 304 also includes a memory/storage 310, which also includes the executable instructions 308 and accompanying data. The hardware layer 304 may also include other hardware modules 312. Instructions 308 held by processing unit 308 may be portions of instructions 308 held by the memory/storage 310.

The example software architecture 302 may be conceptualized as layers, each providing various functionality. For example, the software architecture 302 may include layers and components such as an operating system (OS) 314, libraries 316, frameworks 318, applications 320, and a presentation layer 324. Operationally, the applications 320 and/or other components within the layers may invoke API calls 324 to other layers and receive corresponding results 326. The layers illustrated are representative in nature and other software architectures may include additional or different layers. For example, some mobile or special purpose operating systems may not provide the frameworks/middleware 318.

The OS 314 may manage hardware resources and provide common services. The OS 314 may include, for example, a kernel 328, services 330, and drivers 332. The kernel 328 may act as an abstraction layer between the hardware layer 304 and other software layers. For example, the kernel 328 may be responsible for memory management, processor management (for example, scheduling), component management, networking, security settings, and so on. The services 330 may provide other common services for the other software layers. The drivers 332 may be responsible for controlling or interfacing with the underlying hardware layer 304. For instance, the drivers 332 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 316 may provide a common infrastructure that may be used by the applications 320 and/or other components and/or layers. The libraries 316 typically provide functionality for use by other software modules to perform tasks, rather than rather than interacting directly with the OS 314. The libraries 316 may include system libraries 334 (for example, C standard library) that may provide functions such as memory allocation, string manipulation, file operations. In addition, the libraries 316 may include API libraries 336 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 316 may also include a wide variety of other libraries 338 to provide many functions for applications 320 and other software modules.

The frameworks 318 (also sometimes referred to as middleware) provide a higher-level common infrastructure that may be used by the applications 320 and/or other software modules. For example, the frameworks 318 may provide various GUI functions, high-level resource management, or high-level location services. The frameworks 318 may provide a broad spectrum of other APIs for applications 320 and/or other software modules.

The applications 320 include built-in applications 320 and/or third-party applications 322. Examples of built-in applications 320 may include, but are not limited to, a contacts application, a browser application, a location application, a media application, a messaging application, and/or a game application. Third-party applications 322 may include any applications developed by an entity other than the vendor of the particular system. The applications 320 may use functions available via OS 314, libraries 316, frameworks 318, and presentation layer 324 to create user interfaces to interact with users.

Some software architectures use virtual machines, as illustrated by a virtual machine 328. The virtual machine 328 provides an execution environment where applications/modules can execute as if they were executing on a hardware machine (such as the machine 400 of FIG.4, for example). The virtual machine 328 may be hosted by a host OS (for example, OS 314) or hypervisor, and may have a virtual machine monitor 326 which manages operation of the virtual machine 328 and interoperation with the host operating system. A software architecture, which may be different from software architecture 302 outside of the virtual machine, executes within the virtual machine 328 such as an OS 350, libraries 352, frameworks 354, applications 356, and/or a presentation layer 358.

FIG. 4 is a block diagram illustrating components of an example machine 400 configured to read instructions from a machine-readable medium (for example, a machine-readable storage medium) and perform any of the features described herein. The example machine 400 is in a form of a computer system, within which instructions 416 (for example, in the form of software components) for causing the machine 400 to perform any of the features described herein may be executed. As such, the instructions 416 may be used to implement methods or components described herein. The instructions 416 cause unprogrammed and/or unconfigured machine 400 to operate as a particular machine configured to carry out the described features. The machine 400 may be configured to operate as a standalone device or may be coupled (for example, networked) to other machines. In a networked deployment, the machine 400 may operate in the capacity of a server machine or a client machine in a server-client network environment, or as a node in a peer-to-peer or distributed network environment. Machine 400 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 400 is illustrated, the term “machine” include a collection of machines that individually or jointly execute the instructions 416.

The machine 400 may include processors 410, memory 430, and I/O components 450, which may be communicatively coupled via, for example, a bus 402. The bus 402 may include multiple buses coupling various elements of machine 400 via various bus technologies and protocols. In an example, the processors 410 (including, for example, a central processing unit (CPU), a graphics processing unit (GPU), a digital signal processor (DSP), an ASIC, or a suitable combination thereof) may include one or more processors 412a to 412n that may execute the instructions 416 and process data. In some examples, one or more processors 410 may execute instructions provided or identified by one or more other processors 410. The term “processor” includes a multi-core processor including cores that may execute instructions contemporaneously. Although FIG. 4 shows multiple processors, the machine 400 may include a single processor with a single core, a single processor with multiple cores (for example, a multi-core processor), multiple processors each with a single core, multiple processors each with multiple cores, or any combination thereof. In some examples, the machine 400 may include multiple processors distributed among multiple machines.

The memory/storage 430 may include a main memory 432, a static memory 434, or other memory, and a storage unit 436, both accessible to the processors 410 such as via the bus 402. The storage unit 436 and memory 432, 434 store instructions 416 embodying any one or more of the functions described herein. The memory/storage 430 may also store temporary, intermediate, and/or long-term data for processors 410. The instructions 416 may also reside, completely or partially, within the memory 432, 434, within the storage unit 436, within at least one of the processors 410 (for example, within a command buffer or cache memory), within memory at least one of I/O components 450, or any suitable combination thereof, during execution thereof. Accordingly, the memory 432, 434, the storage unit 436, memory in processors 410, and memory in I/O components 450 are examples of machine-readable media.

As used herein, “machine-readable medium” refers to a device able to temporarily or permanently store instructions and data that cause machine 400 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof The term “machine-readable medium” applies to a single medium, or combination of multiple media, used to store instructions (for example, instructions 416) for execution by a machine 400 such that the instructions, when executed by one or more processors 410 of the machine 400, cause the machine 400 to perform and one or more of the features described herein. Accordingly, a “machine-readable medium” may refer to a single storage device, as well as “cloud-based” storage systems or storage networks that include multiple storage apparatus or devices.

The I/O components 450 may include a wide variety of hardware components adapted to receive input, provide output, produce output, transmit information, exchange information, capture measurements, and so on. The specific I/O components 450 included in a particular machine will depend on the type and/or function of the machine. For example, mobile devices such as mobile phones may include a touch input device, whereas a headless server or IoT device may not include such a touch input device. The particular examples of I/O components illustrated in FIG. 4 are in no way limiting, and other types of components may be included in machine 400. The grouping of I/O components 450 are merely for simplifying this discussion, and the grouping is in no way limiting. In various examples, the I/O components 450 may include user output components 452 and user input components 454. User output components 452 may include, for example, display components for displaying information (for example, a liquid crystal display (LCD) or a projector), acoustic components (for example, speakers), haptic components (for example, a vibratory motor or force-feedback device), and/or other signal generators. User input components 454 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 450 may include biometric components 456 and/or position components 462, among a wide array of other environmental sensor components. The biometric components 456 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 462 may include, for example, location sensors (for example, a Global Position System (GPS) receiver), altitude sensors (for example, an air pressure sensor from which altitude may be derived), and/or orientation sensors (for example, magnetometers).

The I/O components 450 may include communication components 464, implementing a wide variety of technologies operable to couple the machine 400 to network(s) 470 and/or device(s) 480 via respective communicative couplings 472 and 482. The communication components 464 may include one or more network interface components or other suitable devices to interface with the network(s) 470. The communication components 464 may include, for example, components adapted to provide wired communication, wireless communication, cellular communication, Near Field Communication (NFC), Bluetooth communication, Wi-Fi, and/or communication via other modalities. The device(s) 480 may include other machines or various peripheral devices (for example, coupled via USB).

In some examples, the communication components 464 may detect identifiers or include components adapted to detect identifiers. For example, the communication components 464 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 462, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-2) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:
Item 1. A device comprising:
a processor;
an operating system; and
a memory in communication with the processor, the memory comprising executable instructions that, when executed by the processor, cause the operating system to perform functions of:
   receiving an indication to load a software resource for an application, the software resource being in a first language;
   determining if the first language is a preferred language for a user of the device;
   if the first language is not the preferred language for the user of the device, sending a request to a machine translation model to translate the software resource from the first language to the preferred language;
   receiving a translated software resource in the preferred language; and loading the translated software resource.
Item 2. The device of item 1, wherein the executable instructions when executed by the processor, further cause the device to perform functions of:
   determining if the machine translation model to translate the software resource from the first language to the preferred language is stored on the device;
   if the machine translation model is not stored on the device, identifying an alternative preferred language for translating the resource;
   sending a request to an alternative preferred language machine translation model to translate the software resource from the first language to the alternative preferred language;
   receiving the translated software resource in the alternative preferred language; and
loading the translated software resource in the alternative preferred language.
Item 3. The device of item 2, wherein the executable instructions when executed by the processor, further cause the device to perform functions of:
   determining if the alternative preferred language machine translation model is stored on the device; and
   if the alternative preferred language machine translation model is not stored on the device, sending a request to a server via a network to deploy the machine translation model to the device.
Item 4. The device of any one of the preceding items, further comprising a machine translation engine for interpreting the machine translation model, the machine translation engine receiving the request to translate the software resource from the first language to the preferred language and transmitting the request to the machine translation model for translation.
Item 5. The device of item 4, further comprising a plurality of machine translation models including the machine translation model, wherein the machine translation engine identifies one machine translation model from among the plurality of machine translation models to which to send the request.
Item 6. The device of any one of the preceding items, wherein the operating system comprises one or more resource loader components for loading the software resource for the application, at least one of the one or more resource loader components including a modification that enables the operating system to send the request to the machine translation model to translate the software resource from the first language to the preferred language.
Item 7. The device of any one of the preceding items, wherein the machine translation model includes a machine learning (ML) model which receives the software resource as an input and provides the translated software resource in the preferred language as an output.
Item 8. A method for translating a software resource of an application in real time, comprising:
   receiving an indication to load the software resource, the software resource being in a first language;
   determining if the first language is a preferred language for a user;
   if the first language is not the preferred language for the user, sending a request to a machine translation model to translate the software resource from the first language to the preferred language;
   receiving a translated software resource in the preferred language; and
   loading the translated software resource.
Item 9. The method of item 8, further comprising:
determine if the machine translation model to translate the software resource from the first language to the preferred language is stored on a device on which the application is stored;
if the machine translation model is not available on the device, identifying an alternative preferred language for translating the resource;
sending a request to an alternative preferred language machine translation model to translate the software resource from the first language to the alternative preferred language;
receiving the translated software resource in the alternative preferred language; and
loading the translated software resource in the alternative preferred language.
Item 10. The method of item 9, further comprising:
determining if the alternative preferred language machine translation model is stored on the device; and
if the alternative preferred language machine translation model is not stored on the device, sending a request to a server via a network to deploy the machine translation model to the device.
Item 11. The method of any one of items 8-10, further comprising:
receiving a request to launch the application; and
receiving the indication to load the software resource.
Item 12. The method of any one of items 8-11, wherein the machine translation model includes a machine learning (ML) model which receives the software resource as an input and provides the translated software resource in the preferred language as an output.
Item 13. The method of any one of items 8-12, wherein a machine translation engine is used for interpreting the machine translation model, the machine translation engine receiving the request to translate the software resource from the first language to the preferred language and transmitting the request to the machine translation model for translation.
Item 14. The method of any one of items 8-13, further comprising retrieving the preferred language for a user from a database.
Item 15. The method of any one of items 8-14, wherein the application includes a resource file and a code, and the resource contains the software resource.
Item 16. A non-transitory computer readable medium on which are stored instructions that, when executed by an operating system, cause a programmable device to:
   receive an indication to load a software resource for an application, the software resource being in a first language;
   determine if the first language is a preferred language for a user of the device;
if the first language is not the preferred language for the user of the device, sending a request to a machine translation model to translate the software resource from the first language to the preferred language;
   receive a translated software resource in the preferred language; and
   load the translated software resource.
Item 17. The computer readable medium of item 16, wherein the instructions further cause the programmable device to:
   determine if the machine translation model to translate the software resource from the first language to the preferred language is stored on the device;
   if the machine translation model is not available on the device, identify an alternative preferred language for translating the resource;
   send a request to an alternative preferred language machine translation model to translate the software resource from the first language to the alternative preferred language;
   receive the translated software resource in the alternative preferred language; and
   load the translated software resource in the alternative preferred language.
Item 18. The computer readable medium of any of items 16 or 17, wherein the instructions further cause the programmable device to:
   determine if the alternative preferred language machine translation model is stored on the device; and
   if the alternative preferred language machine translation model is not stored on the device, send a request to a server via a network to deploy the machine translation model to the device.
Item 19. The computer readable medium of any one of items 16-18, wherein the programmable device comprises a machine translation engine for interpreting the machine translation model, the machine translation engine receiving the request to translate the software resource from the first language to the preferred language and transmitting the request to the machine translation model for translation.
Item 20. The computer readable medium of any one of items 16-19, wherein the application includes a resource file and a code, and the resource contains the software resource.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A device comprising:
a processor;
an operating system; and
a memory in communication with the processor, the memory comprising executable instructions that, when executed by the processor, cause the operating system to perform functions of:
receiving an indication to load a software resource for an application, the software resource being in a first language;
determining if the first language is a preferred language for a user of the device;
if the first language is not the preferred language for the user of the device, sending a request to a machine translation model to translate the software resource from the first language to the preferred language;
receiving a translated software resource in the preferred language; and
loading the translated software resource.

2. The device of claim 1, wherein the executable instructions when executed by the processor, further cause the device to perform functions of:
determining if the machine translation model to translate the software resource from the first language to the preferred language is stored on the device;
if the machine translation model is not stored on the device, identifying an alternative preferred language for translating the resource;
sending a request to an alternative preferred language machine translation model to translate the software resource from the first language to the alternative preferred language;
receiving the translated software resource in the alternative preferred language; and
loading the translated software resource in the alternative preferred language.

3. The device of claim 2, wherein the executable instructions when executed by the processor, further cause the device to perform functions of:
determining if the alternative preferred language machine translation model is stored on the device; and
if the alternative preferred language machine translation model is not stored on the device, sending a request to a server via a network to deploy the machine translation model to the device.

4. The device of claim 1, further comprising a machine translation engine for interpreting the machine translation model, the machine translation engine receiving the request to translate the software resource from the first language to the preferred language and transmitting the request to the machine translation model for translation.

5. The device of claim 4, further comprising a plurality of machine translation models including the machine translation model, wherein the machine translation engine identifies one machine translation model from among the plurality of machine translation models to which to send the request.

6. The device of claim 1, wherein the operating system comprises one or more resource loader components for loading the software resource for the application, at least one of the one or more resource loader components including a modification that enables the operating system to send the request to the machine translation model to translate the software resource from the first language to the preferred language.

7. The device of claim 1, wherein the machine translation model includes a machine learning (ML) model which receives the software resource as an input and provides the translated software resource in the preferred language as an output.

8. A method for translating a software resource of an application in real time, comprising:
receiving an indication to load the software resource, the software resource being in a first language;
determining if the first language is a preferred language for a user;
if the first language is not the preferred language for the user, sending a request to a machine translation model to translate the software resource from the first language to the preferred language;
receiving a translated software resource in the preferred language; and
loading the translated software resource.

9. The method of claim 8, further comprising:
determine if the machine translation model to translate the software resource from the first language to the preferred language is stored on a device on which the application is stored;
if the machine translation model is not available on the device, identifying an alternative preferred language for translating the resource;
sending a request to an alternative preferred language machine translation model to translate the software resource from the first language to the alternative preferred language;
receiving the translated software resource in the alternative preferred language; and
loading the translated software resource in the alternative preferred language.

10. The method of claim 9, further comprising:
determining if the alternative preferred language machine translation model is stored on the device; and
if the alternative preferred language machine translation model is not stored on the device, sending a request to a server via a network to deploy the machine translation model to the device.

11. The method of claim 8, further comprising:
receiving a request to launch the application; and
receiving the indication to load the software resource.

12. The method of claim 8, wherein the machine translation model includes a machine learning (ML) model which receives the software resource as an input and provides the translated software resource in the preferred language as an output.

13. The method of claim 8, wherein a machine translation engine is used for interpreting the machine translation model, the machine translation engine receiving the request to translate the software resource from the first language to the preferred language and transmitting the request to the machine translation model for translation.

14. The method of claim 8, further comprising retrieving the preferred language for a user from a database.

15. The method of claim 8, wherein the application includes a resource file and a code, and the resource contains the software resource.

16. A non-transitory computer readable medium on which are stored instructions that,
when executed by an operating system, cause a programmable device to:
receive an indication to load a software resource for an application, the software resource being in a first language;
determine if the first language is a preferred language for a user of the device;
if the first language is not the preferred language for the user of the device, sending a request to a machine translation model to translate the software resource from the first language to the preferred language;
receive a translated software resource in the preferred language; and
load the translated software resource.

17. The non-transitory computer readable medium of claim 16, wherein the instructions further cause the programmable device to:
determine if the machine translation model to translate the software resource from the first language to the preferred language is stored on the device;
if the machine translation model is not available on the device, identify an alternative preferred language for translating the resource;
send a request to an alternative preferred language machine translation model to translate the software resource from the first language to the alternative preferred language;
receive the translated software resource in the alternative preferred language; and
load the translated software resource in the alternative preferred language.

18. The non-transitory computer readable medium of claim 17, wherein the instructions further cause the programmable device to:
determine if the alternative preferred language machine translation model is stored on the device; and
if the alternative preferred language machine translation model is not stored on the device, send a request to a server via a network to deploy the machine translation model to the device.

19. The non-transitory computer readable medium of claim 16, wherein the programmable device comprises a machine translation engine for interpreting the machine translation model, the machine translation engine receiving the request to translate the software resource from the first language to the preferred language and transmitting the request to the machine translation model for translation.

20. The computer readable medium of claim 16, wherein the application includes a resource file and a code, and the resource file contains the software resource.
